(19) United States
(12) Patent Application Publication
(10) Pub. No.: US 2014/0352219 A1
(43) Pub. Date: Dec. 4, 2014

(54) Security Insert Panels For Sliding Glass Doors And Windows

(71) Applicant: Robert L. Zieske, Roseville, CA (US)

(72) Inventor: Robert L. Zieske, Roseville, CA (US)

(21) Appl. No.: 14/284,258

(22) Filed: May 21, 2014

Related U.S. Application Data
(60) Provisional application No. 61/956,066, filed on Jun. 1, 2013.

(51) Int. Cl. E06B 5/11; E06B 7/02

(52) U.S. Cl. CPC E06B 5/11; E06B 7/02
USPC 49/124

(57) ABSTRACT

Security insert panels for sliding glass doors and windows. The panels include rigid elements appropriately spaced to allow air ventilation and to prevent human entry. After a sliding door is opened, two panels are installed in vertically stacked relation, within the open portion of the door frame and with one side of both panels within the door jamb. The door is slid within open channels on the other side of the panels. A limit stop is inserted in the bottom channel of the door frame, between the other side of the door and the door frame, preventing the door from being opened. At least one of the panels is adjustable in height, to accommodate sliding doors and windows of different dimensions, and to provide a snug fit for the panels within the upper and lower channels of the door frame. The panels are easily removed by reversing the installation process.

### PRIORITY CLAIM

Pursuant to the provisions of 35 U.S.C. §119(e)(1), Applicant claims the priority of: U.S. Provisional Patent Application Ser. No. 61/956,066 filed Jun. 1, 2013.

### BACKGROUND OF THE INVENTION

1. Field of the Invention

The invention relates generally to improvements in security systems for sliding glass doors and windows with movable elements, which allow air to flow therethrough while preventing human entry into a structure. More particularly, the invention pertains to security insert panels installed in vertically stacked relation, within the open portion of a door or window frame, securely engaging channels within the frame as well as the movable door or window element.

2. Description Of The Prior Art

Sliding glass doors are appreciated because they provide abundant light, convenient ingress and egress, and fresh air ventilation to a home or other structure. A slideable screen door is usually provided as well, to work in conjunction with the slideable glass door. Windows with slideable elements also provide light and ventilation, and they are typically provided with fixed screens to keep out insects and to some degree block the full intensity of the sun's rays. However, screens provided on sliding glass doors and windows provide little security from intruders, as they can easily be penetrated and unlocked or removed.

For the purpose of providing additional security for sliding glass doors and windows that have a movable element, the prior art teaches a number of different approaches. For example, in U.S. Pat. No. 5,105,868, granted to Riise, a Sliding-Door Security Screen is shown. In one embodiment of the invention, a unitary rigid lattice structure is installed between the upper and lower trackways of a sliding door, one vertical side of the lattice structure abutting the door jamb and the other vertical side abutting the outer edge of the sliding door. A second embodiment includes a hinge between upper and lower parts of the same lattice structure, to facilitate handling and storage. See, FIGS. 5 and 6. However, no height adjustability feature for the lattice structure is shown or suggested in this reference.

A Security Ventilation System is disclosed in U.S. Pat. No. 4,226,049, issued to Maust. This arrangement relies upon metal grills which are fashioned to fit either a sliding glass door or a window. The metal grills are held in place on one side by means of a vertical channel fitted to the left channel of the door frame. The other side of the grills are secured within a plurality of vertically-aligned channels fastened to the left-hand stile of the open door. It is evident that Maust requires drilling and modification to the existing door frame and door, for the installation of his system.

Similarly, in Patent Application Publication US 2011/0225887, filed by Manier for Fresh Air Safety Bars, mounting plates welded or bolted to the hinge assembly for the safety bars, must be mounted on the interior wall of the building, immediately adjacent the respective window or sliding-glass door to be fitted with the bars.

In U.S. Pat. No. 7,024,820, issued to Dustin, a Sliding Door Security Assembly is illustrated. This single-piece insert fits into an opening made when a sliding door is partially opened to define an opening between the door jamb and the stile of the facing sliding door. Dustin relies upon a locking shim between the upper transverse member of the insert and the upper track to prevent insert removal. Locking pins, attached to the insert frame and inserted into a mating hole in the facing sliding door style, are provided. A height adjustability feature is shown in FIG. 7, using a pair of threaded shafts 94 and a telescoping adjusting member 80.

It is an object herein to disclose a security insert system employing two separate, but cooperating, security insert panels, for sliding glass doors or windows.

It is a further object to provide security insert panels for sliding glass doors and windows which are easy to handle, adjust, install, remove, and store.

It is also an object herein to disclose a security insert panel which is adjustable in height, yet retains full strength and structural integrity throughout its range of adjustability.

It is also an object herein to teach security insert panels which are easily adjustable to fit a vertical opening in a sliding glass door, ranging from approximately 6.5 feet to approximately 8 feet.

It is further an object herein to disclose security insert panels which may be utilized without any modifications or additions to the existing sliding glass door or window, into which they are installed.

These and other objects will become apparent in the specification and the detailed description of the preferred embodiment, to follow.

### SUMMARY OF THE INVENTION

The device disclosed herein comprises a security insert system for sliding glass doors and windows. The security insert system includes a lower security panel and an upper security panel, arranged in vertically stacked relation. Each of the security panels includes a lower section having: a lower base, sized and configured to slide within both a lower channel and an upper channel of the sliding glass door or window; a jamb side rail, having a pair of parallel flanges sized and configured to slide within a jamb channel of the sliding glass door or window; a stile side rail, parallel to the jamb side rail, and including a pair of parallel flanges sized and configured to receive the jam-engaging stile of the sliding glass door or window.

The lower section of each panel also includes a plurality of security tubes located between the jamb side rail and the stile side rail. The security tubes are attached to the lower base and extend vertically upwardly therefrom. The security tubes are also arranged in spaced relation along the lower base, a predetermined distance from each other and from the opposing side rails. Lastly, the security tubes have open upper ends.

Each of the security panels also includes an upper section having: an upper base; a jamb connection bar attached to one end of the upper base and extending vertically downwardly therefrom; a stile connection bar attached to the other end of the upper base and extending vertically downwardly therefrom; and, a plurality of security rods located between the jamb and the stile connection bars, the security rods being attached to the upper base and extending vertically downwardly therefrom. The security rods are also arranged in spaced relation along the upper base a predetermined distance from each other and from the connection bars. Lastly, the security rods are sized and configured to slide within the open ends of the security tubes.

For the purpose of interconnecting the lower section and the upper section of the panels together, fastening means is provided for adjustably connecting the jamb connection bar to the jamb side rail, and the stile connection bar to said stile side rail. In this case, a plurality of apertures along the connection bars and the rails in combination with bolts and nuts provide the height adjustability function and the fastening function.

In use, the combined height of lower security panel and/or the height of the upper security panel are adjusted closely to match, but not exceed, the vertical distance between the bottom of the lower channel and the top of the upper channel of the sliding glass door or window. For a relatively short sliding glass door, leaving the lower security panel at its minimum height may suffice, so that only the upper security panel needs to be adjusted to make up the required height. However, for a sliding glass door that is 8 feet or so in height, both the upper and lower panels will likely have to be extended appropriately.

After height adjustment of the panels is completed, the base of the lower security panel is inserted within the lower channel of the sliding glass door or window, and slid within the lower channel until the jamb side rail of the lower security panel is inserted within the jamb channel of the sliding glass door or window.

The upper security panel is preferably identical in structure to the lower security panel. However, when the upper security panel is installed, it is inverted end for end, with respect to orientation of the lower security panel. Thus, the lower base of said upper security panel is inserted within the upper channel of the sliding glass door or window. And, the upper base of the upper security panel is slid over the lower security panel with the upper base of the upper security panel resting over the upper base of said lower security panel, the two panels being arranged in vertically stacked relation.

Next, the upper security panel is slid until the jamb side rail of the upper security panel is inserted within the jamb channel of the sliding glass door or window. To secure the panels, the jam-engaging stile of the sliding glass door or movable element of a window is slid until it is inserted within the stile side rail of the upper security panel and the stile side rail of the lower security panel.

To prevent the sliding glass door or movable window element from being slid to an open position, a limit stop member is provided. This may be in the form of a pole or bar, which may also be adjustable in length. The limit stop member is preferably located in the lower channel of the sliding glass door or window between its other stile and the other jamb of the sliding glass door or window.

### BRIEF DESCRIPTION OF THE DRAWINGS

FIG. 1 is a left front perspective view of a sliding glass door, or a window with a movable element, fitted with a lower security insert panel, an upper security insert panel, and a limit stop member;

FIG. 2 is an exploded perspective view of the lower section and the upper section of a security insert panel;

FIG. 3 is a left front perspective view of an assembled security insert panel;

FIG. 4 is a left front perspective view of a lower security insert panel and an upper security insert panel, arranged in stacked relation;

FIG. 5 is a left front perspective view of a fixed height lower security insert panel and an adjustable upper security insert panel, arranged in stacked relation;

FIG. 6 is a cross-sectional view taken on the line 6-6 shown in FIG. 1;

FIG. 7 is a detail inset view of the structure encircled by the circular broken line shown in FIG. 1; and,

FIG. 8 is a perspective view of the adjustable length limit stop member, the broken line representation being included to show an alternative length for the member.

### DETAILED DESCRIPTION OF THE PREFERRED EMBODIMENT

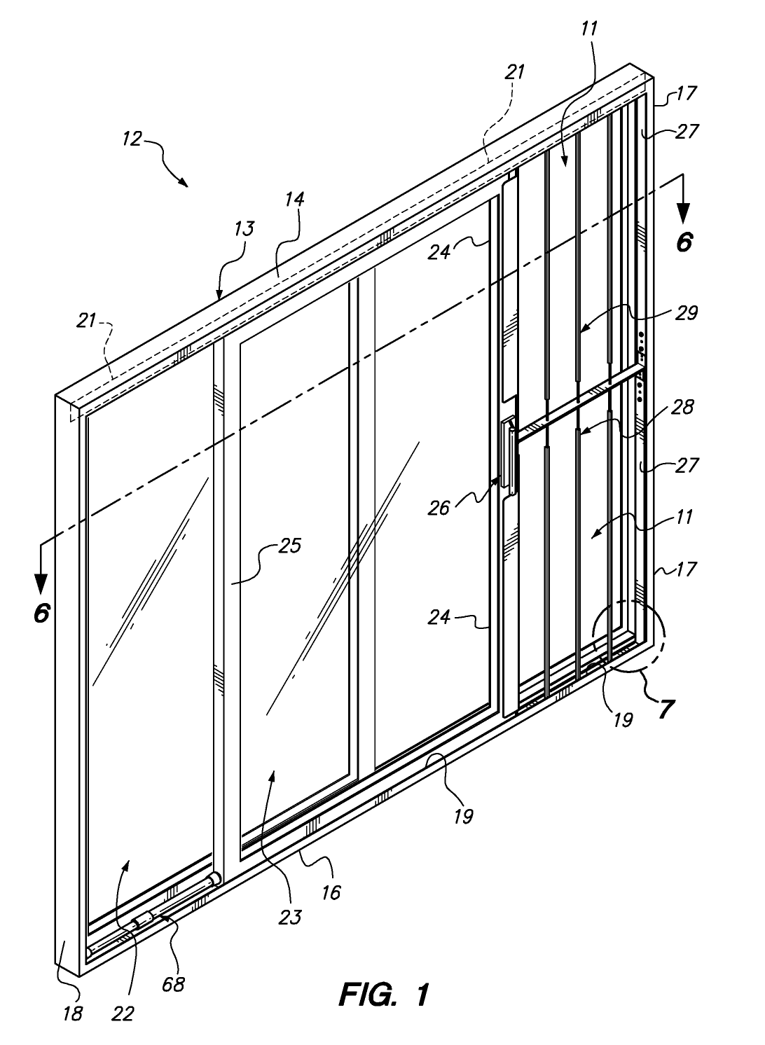

Turning now to the drawings, FIG. 1 shows the security insert system 11 of the present invention, fully assembled an installed within a sliding glass door 12. It should be understood that the security insert system 11 may also be used in conjunction with a window having either a horizontally or a vertically movable element or panel, but since such a window will have substantially the same structure as the sliding glass door 12, there is no need here to replicate the description or features of that structure.

Sliding glass door 12 has a peripheral frame 13, including a head 14, a sill 16, a first jamb 17, and an opposing second jamb 18. Sill 16 includes an upwardly facing lower channel 19, extending from jamb 17 to jamb 18. Likewise, head 14 includes a downwardly facing upper channel 21, extending from jamb 17 to jamb 18. Sliding glass door 12 also includes a stationary door panel 22, and a slideable door panel 23.

Slideable door panel 23 includes upper and lower rollers (not shown) which support and provide registration for panel 23, for sliding translation within upper channel 21 and lower channel 19. Slideable door panel 23 also includes a jam-engaging stile 24 on one side, fitted with hardware 26, such as a handle and a locking mechanism. Sliding door panel 23 also includes a stile 25 on the other side of the door panel 23.

Jamb 17 includes an inwardly facing jamb channel 27, sized and configured to receive jam-engaging stile 24, when the slideable door panel 23 is in a closed position. Jamb channel 27 also includes a receiver or an aperture (not shown) to which the locking mechanism of hardware 26 couples to lock slideable door panel 23 securely to the peripheral frame 13.

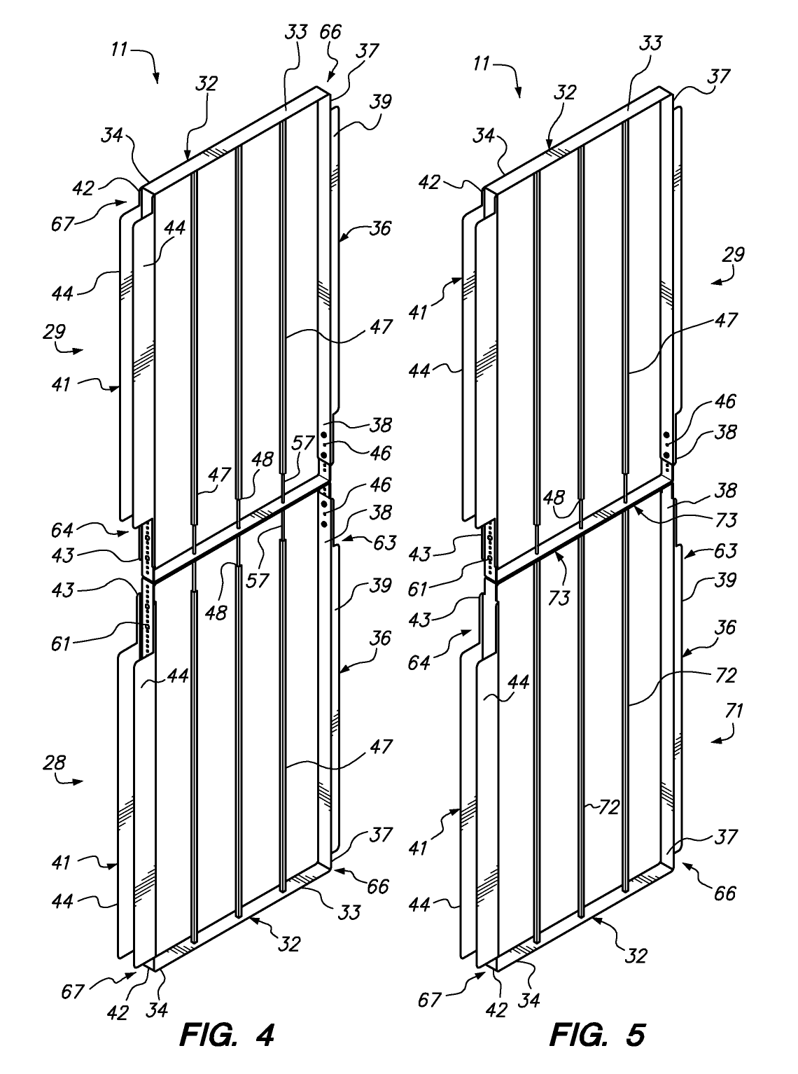

The security insert system 11 comprises a lower security panel 28 and an upper security panel 29. In the preferred embodiment of the system 11, both security panels 28 and 29 are identical in construction. However, as will be explained more fully below, when panels 28 and 29 are installed within a sliding glass door 12, upper panel 29 is inverted, or flipped top for bottom, with respect to the orientation of lower panel 28. (See, FIG. 4).

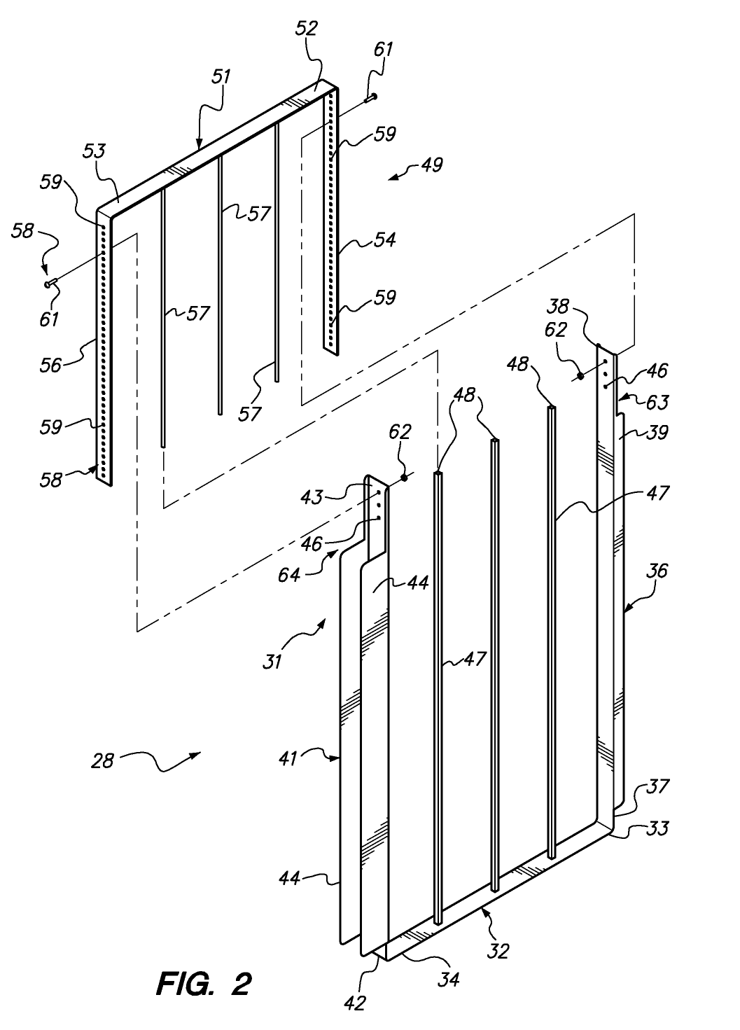

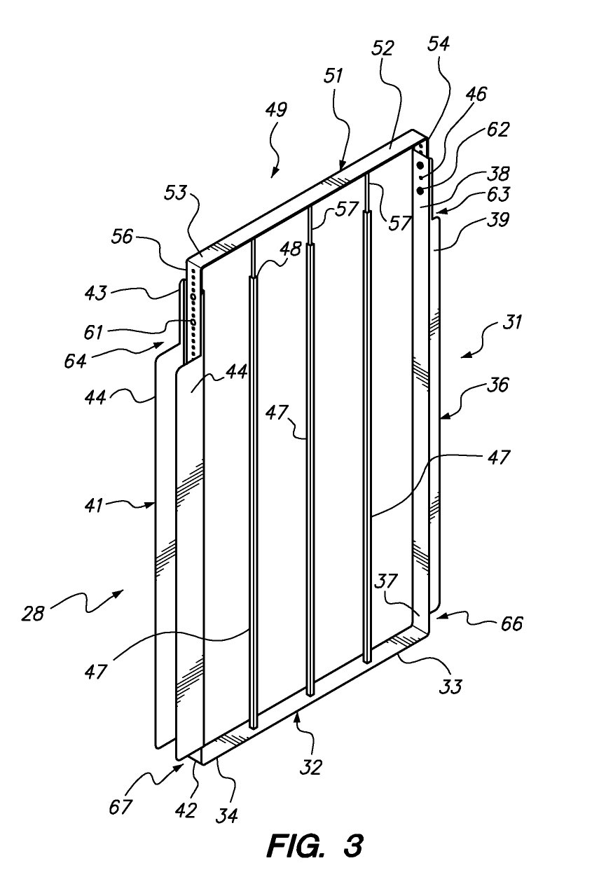

As shown in FIGS. 2 and 3, lower security panel 28 includes a lower section 31 having an elongated lower base 32 with a jamb end 33 and a door stile end 34. The lower base 32 is sized and configured to slide either within the lower channel 19 or the upper channel 21 of a sliding glass door 12 or window. A jamb side rail 36 is provided, having a lower end 37 attached to the jamb end 33 of lower base 32 and extending vertically therefrom. The jamb side rail 36 further has an upper end 38, including a pair of parallel flanges 39 generally extending between the lower end 37 and the upper end 38. Flanges 39 are sized and configured to slide within the jamb channel 27 of the sliding glass door 12 in the same fashion as jamb-engaging stile 24.

Lower section 31 also includes a stile side rail 41. Stile side rail 41 has a lower end 42 attached to the door stile end 34 of lower base 32, and extends vertically therefrom. Stile side rail 41 further has an upper end 43, and a pair of flanges 44 sized and configured to receive the stile 24 of the sliding glass door or window in the same fashion as jamb channel 27. A plurality of vertically extending apertures 46 is provided along the upper end 38 of jamb side rail 36, and along upper end 43 of stile side rail 41.

Lower section 31 further includes a plurality of security tubes 47 located between side rails 36 and 41, attached to lower base 32 and extending vertically therefrom. Security tubes 47 are arranged in spaced relation along lower base 32 a predetermined distance from each other and from the side rails 36 and 41. This predetermined distance is selected to prevent the ingress or egress of a person, while providing sufficient open passageways for air ventilation through the security panel 28. Security tubes 47 are preferably square in cross-section, but other configurations such as circular or faceted walls for the tubes, would perform equally well. Security tubes 47 are also provided with open upper ends 48.

Lower security panel 28 also has an upper section 49. Upper section 49 comprises an elongated upper base 51, with a jamb end 52 and a door stile end 53. Upper section 49 also includes jamb connection bar 54 and a stile connection bar 56. Jamb connection bar 54 has an upper end attached to the jamb end 52 of said upper base 51, extending vertically therefrom. In similar fashion, stile connection bar 56 has an upper end attached to the stile end 52 of upper base 51, extending vertically therefrom.

Upper section 49 further includes a plurality of security rods 57 located between connection bars 54 and 56, and attached to upper base 51 extending vertically therefrom. Security rods 57 are arranged in spaced relation along upper base 51 a predetermined distance from each other and from connection bars 54 and 56, so as to provide coaxial alignment with security tubes 47 when upper section 49 is assembled with lower section 31. Further to that end, security rods 57 are sized and configured to slide within open ends 48 of security tubes 47. (See, FIGS. 2 and 3). Security rods 57 are preferably solid and circular in cross-section, but other configurations would perform equally well.

Interconnection means 58 is provided for adjustably connecting upper section 49 to lower section 31, for the purpose of establishing a predetermined distance between lower base 32 and upper base 51. Interconnection means 58 comprises a plurality of vertically spaced apertures 59 arranged both along jamb connection bar 54 and along stile connection bar 56, and a plurality of fasteners in the form of bolts 61 and nuts 62. Insertable locking pins, lever arms having a hook or a recess for engaging respective pins, or locking lever cam arrangements would all provide suitable substitutions. Previously mentioned apertures 46 in the upper ends 38 and 43 of the jamb side rail 36 and the stile side rail 41, are also part of interconnection means 58.

When upper section 49 is lowered over lower section 31, connection bars 54 and 56 slide over the outside portions of respective side rails 41 and 36. Simultaneously, care is taken to align and insert the ends of rods 57 into open upper ends 48. Once the predetermined distance between lower base 32 and upper base 51 is achieved, bolts 61 are passed through apertures 59 and 46, and secured in place with nuts 62. (See, FIGS. 2 and 3).

It should also be noted that the upper ends of flanges 39 on the jamb side rail 36 include a jamb cutout 63, to accommodate any pre-existing jam hardware. Similarly, the upper ends of flanges 44 on the stile side rail 41 includes a stile cutout 64, to accommodate any pre-existing stile hardware. Such pre-existing hardware may include locking levers, receivers, grips, and handles and the like.

To prevent mechanical interference and to provide clearance between the flanges 39 and 44 and the walls of lower channel 19 in the sill 16, channel cutouts 66 and 67 are provided. These same channel cutouts 66 and 67 perform the identical clearance function for upper security panel 29, with respect to avoiding mechanical interference with the walls of upper channel 21 in head 14. (See, FIGS. 4 and 7).

To fit a sliding glass door 12 with the security insert system 11, the slideable door panel 23 is first moved into an open position. The lower base 32 of lower security panel 28 is inserted within the lower channel 19 of the sliding glass door 12, and then slid within the lower channel until the jamb side rail 36 of the lower security panel 28 is inserted within the jamb channel 27 of the sliding glass door.

The upper security panel 29 is inverted top for bottom in preparation for installation. Next, the lower base 32 of the upper security panel 29 is inserted within the upper channel 21 of the sliding glass door 12. The upper security panel 29 is then slid over the top of the lower security panel 28, with the upper base 51 of upper security panel 29 resting over the upper base 51 of the lower security panel 28, in vertically stacked relation. The upper security panel 29 is slid then until the jamb side rail 36 of the upper security panel 29 is inserted within the jamb channel 27 of the sliding glass door 12.

The slideable door panel 23 is slid in a closing direction until its jamb-engaging stile 24 of the sliding glass door 12 is fully inserted within the stile side rail 41 of the upper security panel 29 and the stile side rail 41 of the lower security panel 28. If the door 12 is equipped with a sliding screen door (not shown), that screen door can be left in place, preventing insects and the like from entering the dwelling or structure.

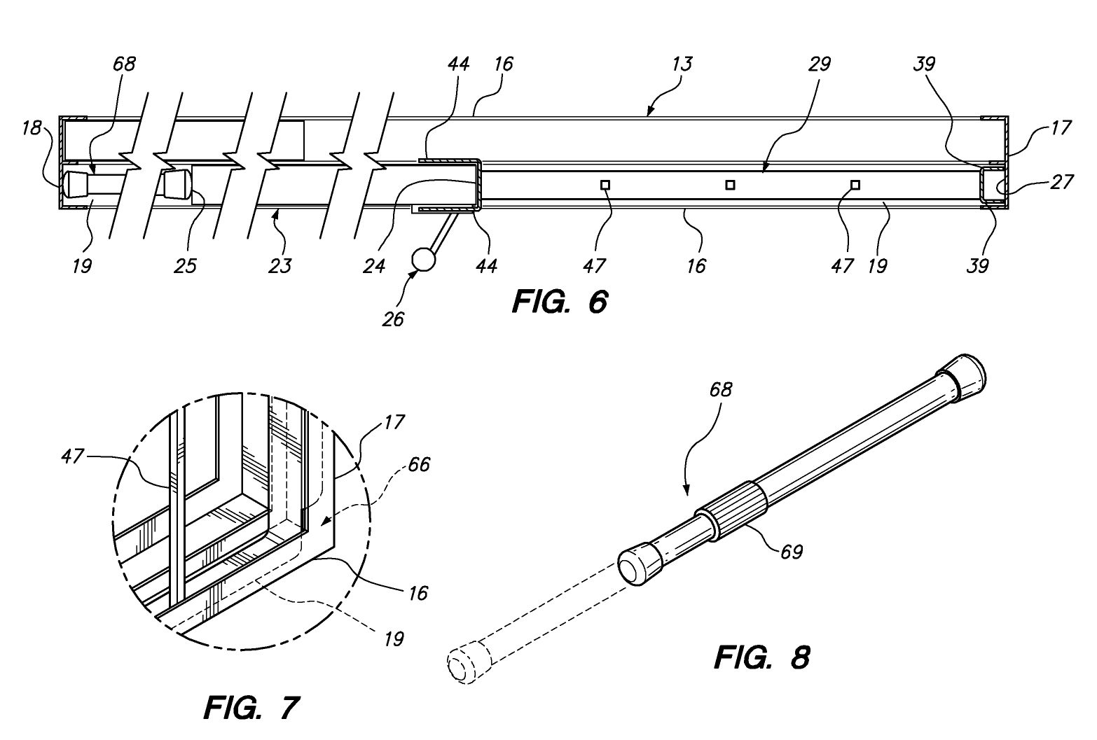

For the purpose of ensuring that the slideable door panel 23 cannot be moved toward an open position by an intruder, a limit stop 68 is inserted between the stile 25 on the other side of the door panel and the second jamb 18. (See, FIG. 6). Limit stop 68 may be a simple pole or rod of the desired length, inserted within the lower channel 19. It is preferable to employ a limit stop 68 having the capability of being adjusted in length, as shown in FIG. 8. Such a limit stop 68 may include a knurled grip 69, rotatable into a release position for adjustment of the length of the limit stop, and rotatable into a lock position for use with the security insert system 11. It should be noted that the limit stop 68 does not have to be placed in the lower channel 19. It may also be secured horizontally at a higher location, or it may be extended and positioned at an angle to form a wedge against stile 25 of door panel 23.

The security insert system 11 is easily removed from the sliding glass door 12, by reversing the installation process. The limit stop 68 is removed first. After sliding the door panel 23 slightly out of engagement with the stile side rails 41, the upper panel 29 and the lower panel 28 are easily removed, in that order. There is no other hardware, fixtures, or attachments to the door or the surrounding walls which needs to be removed.

The identical security insert system 11 may be used in the same fashion with a window, having either a horizontally or a vertically sliding movable panel. The security insert panels would only have to sized appropriately for a window. Because the panels 28 and 29 and the limit stop 68 are relatively small, separate, and lightweight structures, they are easily handled for storage underneath a bed or in a closet, until needed.

Preferably, at least one of the security insert panels 28 or 29, is adjustable in height, to accommodate sliding doors and windows of different dimensions and to provide a snug fit for the panels within the upper and lower channels of the door or window frame. An alternative embodiment of the security insert system 11 is shown in FIG. 5, which includes an upper adjustable security panel 29 and a fixed height security insert panel 71. For brevity and clarity, the same numerals have been used to identify the identical structural elements in security insert panel 71, as have been used previously. New numerals are only used for structures which are not identical to structures previously described.

Because it has a fixed height, security insert panel 71 includes security tubes 72 which extend from lower base 32 to an upper base 73. As there is no adjustability feature, upper base 73 is affixed directly to upper end 43 of stile side rail 41, and to upper end 38 of jamb side rail 36. In all other respects, security insert panel 71 is identical to previously described lower security panel 28 and upper security panel 29. And, in installation, security panel 71 is installed precisely as described for lower security panel 28, except no adjustment of is height is possible or needed. Only upper security panel 29 needs to be adjusted for height, in the use of the security insert system 11 shown in FIG. 5.

What is claimed is:

1. A security insert system for sliding glass doors and windows, comprising: a lower security panel and an upper security panel, each said security panel including:
a. a lower base sized and configured to slide within a lower channel and an upper channel of the sliding glass door or window;
b. a jamb side rail, said jamb side rail including a pair of parallel flanges sized and configured to slide within a jamb channel of the sliding glass door or window;
c. a stile side rail, said stile side rail being parallel to said jamb side rail, and including a pair of parallel flanges sized and configured to receive the stile on one side of the sliding glass door or window;
d. a plurality of security tubes located between said side rails, said security tubes being attached to said lower base and extending vertically therefrom, said security tubes being arranged in spaced relation along said lower base a predetermined distance from each other and from said side rails, said security tubes having open upper ends;
e. an upper base;
f. a jamb connection bar and a stile connection bar, said jamb connection bar being attached to one end said of said upper base and extending vertically therefrom, and said stile connection bar being attached to the other end of said upper base and extending vertically therefrom;
g. a plurality of security rods located between said connection bars, said security rods being attached to said upper base and extending vertically therefrom, said security rods being arranged in spaced relation along said upper base a predetermined distance from each other and from said connection bars, said security rods being sized and configured to slide within said open ends of said security tubes; and,
h. fasteners for adjustably connecting said jamb connection bar to said jamb side rail and said stile connection bar to said stile side rail, whereby said lower base of said lower security panel is inserted within the lower channel of the sliding glass door or window and slid within the lower channel until said jamb side rail of said lower security panel is inserted within the jamb channel of the sliding glass door or window, and said lower base of said upper security panel is inserted within the upper channel of the sliding glass door or window and said upper security panel is then slid over said lower security panel with said upper base of said upper security panel resting over said upper base of said lower security panel in vertically stacked relation, said upper security panel is slid until said jamb side rail of said upper security panel is inserted within the jamb channel of the sliding glass door or window, and the stile of the sliding glass door or movable element of a window is slid until it is inserted within said stile side rail of said upper security panel and said stile side rail of said lower security panel.

2. A security insert system as in claim 1 including a limit stop member, said limit stop member being located between a stile on the other side of the sliding glass door the other jamb of the sliding glass door or window, preventing any opening movement of the sliding glass door.

3. A security insert system as in claim 2 in which said limit stop member is adjustable in length, and in which said limit stop member is installed within the lower channel of the sliding glass door or window.

4. A security insert system as in claim 1 in which said upper and lower security panel inserts have a combined height, when assembled in stacked relation, within the range of approximately 6.5 feet to 8 feet.

5. A security insert system as in claim 1 in which said security tubes are square in cross-section and said security rods are circular in cross-section.

6. A security insert system as in claim 1 in which said jamb connection bars and said jamb side rails of said upper and lower security panels include a plurality of vertically spaced apertures, and in which said stile connection bars and said stile side rails of said upper and lower security panels include a plurality of vertically spaced apertures, and in which said fasteners include bolts passing through said apertures, said bolts being secured by a respective nut.

7. A security insert system as in claim 1, in which said flanges on said jamb side rails of said lower and upper security panels and said flanges on said stile side rails of said lower and upper security panels include cutouts on one end to accommodate hardware on the stile on one side of the sliding glass door or the window.

8. A security insert system as in claim 7, in which said flanges on said jamb side rails of said lower and upper security panels and said flanges on said stile side rails of said lower and upper security panels include cutouts on the other end to provide clearance between said flanges, and the upper channel and the lower channel of the sliding glass door or the window.

9. A security insert panel for sliding glass doors and windows, comprising:
a. a lower section, said lower section having: an elongated lower base with a jamb end and a door stile end, said lower base being sized and configured to slide within a lower channel or an upper channel of the sliding glass door or window; a jamb side rail, said jamb side rail having a lower end attached to said jamb end of said lower base and extending vertically therefrom, said jamb side rail further having an upper end, said jamb side rail further including a pair of parallel flanges being sized and configured to slide within a jamb channel of the sliding glass door or window; a stile side rail, said stile side rail having a lower end attached to said door stile end of said lower base and extending vertically therefrom, said stile side rail further having an upper end, said stile side rail including a pair of flanges being sized and configured to receive the stile of the sliding glass door or window; and, a plurality of apertures along said upper end of said jamb side rail and along said upper end of said stile side rail; said lower section further including a plurality of security tubes between said side rails attached to said elongated base and extending vertically therefrom, said security tubes being arranged in spaced relation along said elongated base a predetermined distance from each other and from said side rails, said security tubes having open upper ends;
b. an upper section, said upper section having: an elongated upper base with a jamb end and a door stile end; a jamb connection bar and a stile connection bar, said jamb connection bar having an upper end attached to said jamb end of said upper base and extending vertically therefrom, and said stile connection bar having an upper end attached to said stile end of said upper base and extending vertically therefrom; said upper section further including a plurality of security rods between said connection bars attached to said upper base and extending vertically therefrom, said security rods being arranged in spaced relation along said upper base a predetermined distance from each other and from said connection bars said security rods being sized and configured to slide within said open ends of said security tubes; and,
c. interconnection means for adjustably connecting said lower section to said upper section to establish a predetermined distance between said lower base and said upper base.

10. A security insert panel as in claim 9, in which said security tubes are square in cross-section and said security rods are circular in cross-section.

11. A security insert panel as in claim 9, in which said flanges on said jamb side rails of said lower section and said flanges on said stile side rails of said lower section include cutouts on one end to accommodate hardware on the stile on one side of the sliding glass door or the window.

12. A security insert panel as in claim 11, in which said flanges on said jamb side rails of said lower section and said flanges on said stile side rails of said lower section include cutouts on the other end of said flanges to provide clearance between said flanges, and either the upper channel or the lower channel of the sliding glass door or the window.

13. A security insert panel as in claim 9, in which said interconnection means comprises a plurality of vertically spaced apertures along said jamb connection bar and said jamb side rail of said upper and a plurality of vertically spaced apertures along said stile connection bar and said stile side rail, and in which said interconnection means further includes respective fasteners passing through said apertures and being respectively secured to said connection bars.

14. A security insert panel for sliding glass doors and windows, comprising:
a. a lower section, said lower section having: a lower base with a transverse dimension slightly smaller than a lower channel and an upper channel of the sliding glass door or window; a jamb side rail, said jamb side rail including a pair of parallel flanges having a transverse dimension slightly smaller than a jamb channel of the sliding glass door or window; a stile side rail, said stile side rail being parallel to said jamb side rail and having flanges with a transverse dimension slightly larger than the stile of the sliding glass door or window; a plurality of security tubes located between said side rails, said security tubes being attached to said lower base and extending vertically therefrom, said security tubes being arranged in spaced relation along said lower base a predetermined distance from each other and from said side rails, said security tubes having open upper ends;
b. an upper section, said upper section having: an upper base; a jamb connection bar and a stile connection bar, said jamb connection bar being attached to one end said of said upper base and extending vertically therefrom, and said stile connection bar being attached to the other end of said upper base and extending vertically therefrom; said upper section further including a plurality of security rods between said connection bars, said security rods being attached to said upper base and extending vertically therefrom, said security rods being arranged in spaced relation along said upper base a predetermined distance from each other and from said connection bars, said security rods being sized and configured to slide within said open ends of said security tubes; and,
c. interconnection means for adjustably connecting said lower section to said upper section to establish a predetermined distance between said lower base and said upper base.

15. A security insert panel as in claim 14, in which said security tubes are square in cross-section and said security rods are circular in cross-section.

16. A security insert panel as in claim 14, in which said flanges on said jamb side rails of said lower section and said flanges on said stile side rails of said lower section include cutouts on one end to accommodate hardware on the stile on one side of the sliding glass door or the window.

17. A security insert panel as in claim 16, in which said flanges on said jamb side rails of said lower section and said flanges on said stile side rails of said lower section include cutouts on the other end of said flanges to provide clearance between said flanges, and either the upper channel or the lower channel of the sliding glass door or the window.

18. A security insert panel as in claim 14, in which said interconnection means comprises a plurality of vertically spaced apertures along said jamb connection bar and said jamb side rail, and a plurality of vertically spaced apertures along said stile connection bar and said stile side rail, and in which said interconnection means further includes respective fasteners passing through said apertures and being respectively secured to said connection bars.
